(19) United States
(12) Patent Application Publication
(10) Pub. No.: US 2025/0068617 A1
(43) Pub. Date: Feb. 27, 2025

(54) INTERNET OF THINGS TERMINAL OBJECT MODEL STANDARDIZATION PROCESSING METHOD AND APPARATUS, COMPUTER DEVICE AND STORAGE MEDIUM

(71) Applicant: E SURFING IOT CO., LTD., Guangzhou, Guangdong (CN)

(72) Inventors: Siyuan JIANG, Guangzhou, Guangdong (CN); Yalei WANG, Guangzhou, Guangdong (CN); Jun ZHU, Guangzhou, Guangdong (CN); Guoqing GENG, Guangzhou, Guangdong (CN); Yiming WANG, Guangzhou, Guangdong (CN); Jie GONG, Guangzhou, Guangdong (CN)

(21) Appl. No.: 18/724,857

(22) PCT Filed: Dec. 20, 2022
(86) PCT No.: PCT/CN2022/140375

§ 371 Date: Aug. 7, 2024

(30) Foreign Application Priority Data
Dec. 31, 2021 (CN) 202111662005.7

(51) Int. Cl. G06F 16/23; G06F 16/27

(52) U.S. Cl. CPC G06F 16/23; G06F 16/27

(57) ABSTRACT

A method for standardizing an object model of an Internet of Things (IoT) terminal includes requesting an IoT terminal connected to the IoT management platform to upload respective object model data and if the IoT terminal supports uploading its own object model data, updating, according to the object model data uploaded by the IoT terminal, a first object model that matches the object model data. If the IoT terminal does not support uploading its own object model data, the method includes acquiring an object model log of the IoT terminal, and formatting log data in the object model log to obtain target log data. The method further includes sending the target log data to a big data platform to enable the big data platform to generate a second object model according to the target log data, and if the second object model is received, storing the second object model.

### TECHNICAL FIELD

The present disclosure relates to the technical field of the Internet of Things (IoT), and particularly relates to a method and apparatus for standardizing an object model of an Internet of Things terminal, a computer device, and a storage medium.

### BACKGROUND

With the exponential growth in the number of IoT terminals and their connections to IoT, the pressure and workload of operation and maintenance management of IoT terminal devices will also increase unprecedentedly, resulting in constraints on related business systems and the development of IoT businesses. At present, when a new IoT terminal is connected to the relevant IoT management platform, it needs to configure or register an object model of the new device. Only after completing the configuration or registration, the IoT terminal can be correctly managed upon connecting to the IoT management platform.

The configuration or registration of the object model includes the configuration of device attributes, device services, and device time. Depending on the types of IoT terminals, the number of device attributes, device services, and device time to be configured varies, and can range up to hundreds. At present, most IoT terminals cannot actively upload object model data, so manual configuration or registration of the object model is required. In cases where the workload is substantial, configuration errors are highly likely to occur.

### SUMMARY

Embodiments of the present disclosure provide a method and apparatus for standardizing an object model of an Internet of Things (IoT) terminal, a computer device, and a storage medium.

Regardless of whether IoT terminals support uploading object model data, corresponding object models can be generated to facilitate the management of different types of IoT terminals.

In a first aspect, an embodiment of the present disclosure provides a method for standardizing an object model of an Internet of Things (IoT) terminal, including:
requesting an IoT terminal connected to the IoT management platform to upload respective object model data;
if the IoT terminal supports uploading its own object model data, updating, according to the object model data uploaded by the IoT terminal, a first object model that matches the object model data, where the first object model is stored in the IoT management platform;
if the IoT terminal does not support uploading its own object model data, acquiring an object model log of the IoT terminal, and formatting log data in the object model log to obtain target log data;
sending the target log data to a big data platform to enable the big data platform to generate a second object model according to the target log data and return the second object model to the IoT management platform; and
if the second object model is received, storing the second object model.

In a second aspect, an embodiment of the present disclosure further provides an apparatus for standardizing an object model of an Internet of Things (IoT) terminal, including:
a first request unit, configured to request an IoT terminal connected to an IoT management platform to upload respective object model data;
a first update unit, configured to, if the IoT terminal supports uploading its own object model data, update, according to the object model data uploaded by the IoT terminal, a first object model that matches the object model data, where the first object model is stored in the IoT management platform;
a first acquisition unit, configured to, if the IoT terminal does not support uploading its own object model data, acquire an object model log of the IoT terminal, and format log data in the object model log to obtain target log data;
a first sending unit, configured to send the target log data to a big data platform to enable the big data platform to generate a second object model according to the target log data and return the second object model to the IoT management platform; and
a first storage unit, configured to, if the second object model is received, store the second object model.

In a third aspect, an embodiment of the present disclosure further provides a computer device, including a memory and a processor, where the memory has computer programs stored therein which, when executed by the processor, cause the processor to implement the above method.

In a fourth aspect, an embodiment of the present disclosure further provides a computer-readable storage medium, having computer programs stored therein which, when executed by a processor, cause the processor to implement the above method.

Embodiments of the present disclosure provide a method and apparatus for standardizing an object model of an Internet of Things (IoT) terminal, a computer device, and a storage medium. In the embodiments of the present disclosure, for an IoT terminal that supports uploading object model data, the IoT management platform can directly acquire its object model data, and update, according to the object model data, the first object model stored in the IoT management platform. For an IoT terminal that does not support uploading object model data, the IoT management platform can acquire the object model log uploaded by the IoT terminal, then format the log data of the object model log to enable the big data platform to generate the second object model according to the target log data and send the second object model to the IoT management platform, so that regardless of whether supporting uploading object model data, the IoT terminal can be managed through a corresponding object model, which improves the efficiency of the IoT management platform in managing IoT terminals.

### BRIEF DESCRIPTION OF DRAWINGS

In order to more clearly illustrate the technical solutions in the embodiments of the present disclosure, the accompanying drawings required to be used in the description of the embodiments will be briefly introduced below. Obviously, the accompanying drawings in the following description are some embodiments of the present disclosure. For those of ordinary skill in the art, other accompanying drawings can also be obtained based on these accompanying drawings without creative effort.

FIG. 1 is a schematic flowchart of a method for standardizing an object model of an IoT terminal provided by an embodiment of the present disclosure;

FIG. 2 is a schematic diagram of an application scenario of a method for standardizing an object model of an IoT terminal provided by an embodiment of the present disclosure;

FIG. 3 is an interaction flowchart between an IoT management platform and a big data platform in a method for standardizing an object model of an IoT terminal provided by an embodiment of the present disclosure;

FIG. 4 is a schematic sub-flowchart of a method for standardizing an object model of an IoT terminal provided by an embodiment of the present disclosure;

FIG. 5 is an interaction flowchart between an IoT management platform and a big data platform in a method for standardizing an object model of an IoT terminal provided by an embodiment of the present disclosure;

FIG. 6 is a schematic block diagram of an apparatus for standardizing an object model of an IoT terminal provided by an embodiment of the present disclosure;

FIG. 7 is a schematic block diagram of an apparatus for standardizing an object model of an IoT terminal provided by another embodiment of the present disclosure; and

FIG. 8 is a schematic block diagram of a computer device provided by an embodiment of the present disclosure.

### DETAILED DESCRIPTION

The technical solutions in the embodiments of the present disclosure will be clearly and completely described below with reference to the accompanying drawings in the embodiments of the present disclosure. Apparently, the described embodiments are part of, not all of, the embodiments of the present disclosure. Based on the embodiments of the present disclosure, all other embodiments obtained by those of ordinary skill in the art without making creative efforts fall within the scope of protection of the present disclosure.

It should be understood that, when used in this specification and the appended claims, the terms “comprise” and “include” indicate the presence of described features, integers, operations, elements and/or components, but do not exclude the presence or addition of one or more of other features, integers, operations, elements, components and/or collections thereof.

It should also be understood that the terms used in the specification of the present disclosure are merely for the purpose of describing particular embodiments and are not intended to limit the present disclosure. As used in the specification and appended claims of the present disclosure, the singular forms “one”, “a/an”, and “the” are intended to include the plural forms unless the context clearly dictates otherwise. It is to be further understood that the term “and/or” as used in the specification and appended claims of the present disclosure refers to and includes any and all possible combinations of one or more of the associated listed items.

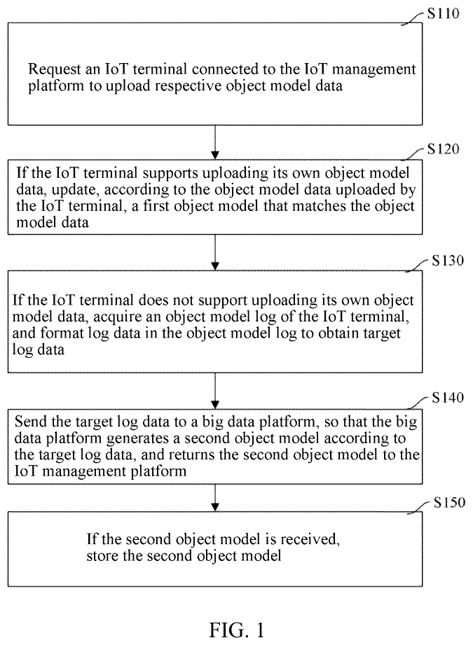

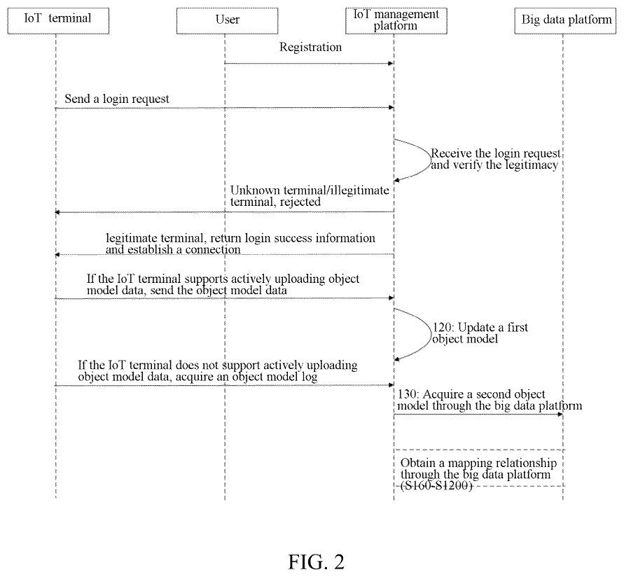

Referring to FIGS. 1 and 2, FIG. 1 is a schematic flowchart of a method for standardizing an object model of an IoT terminal provided by an embodiment of the present disclosure. FIG. 2 is an application scenario diagram of a method for standardizing an object model of an IoT terminal provided by an embodiment of the present disclosure. The method for standardizing an object model of an IoT terminal according to the embodiment of the present disclosure is applied to an IoT management platform, which can be deployed on a computer device and can interact with the IoT terminal and a big data platform. As shown in FIG. 1, the method includes steps S110 to S140.

In S110, an IoT terminal connected to the IoT management platform is requested to upload respective object model data.

In some embodiments, such as this embodiment, before step S110, the method may include the following steps: if a login request sent by the IoT terminal is received, the login request is analyzed to obtain basic information of the IoT terminal, and the basic information is verified to determine whether the IoT terminal is a legitimate device; if the IoT terminal is a legitimate device, login success information is returned to the IoT terminal and a connection with the IoT terminal is established; and if the IoT terminal is an illegitimate device, the login request of the IoT terminal is rejected.

In an embodiment of the present disclosure, the IoT terminal needs to register with the IoT management platform before sending a login request. During registration, the user of the IoT terminal needs to upload relevant information such as identity information and basic information of the IoT terminal. After the user completes the upload, the IoT terminal management platform automatically generates object model upload TOPIC configuration information, log upload TOPIC configuration information and event upload TOPIC configuration information of the IoT terminal. The object model upload TOPIC configuration information includes: /version number/tenant ID/models/; the log upload TOPIC configuration information includes: /version number/tenant ID/data reports/; the event upload TOPIC configuration information includes: /version number/tenant ID/event reports/. The version number starts from V1 by default. If the type of the IoT terminal has been registered on the IoT management platform before, there is no need to register the type of the IoT terminal. Through the above TOPIC configuration information, the IoT management platform can master the basic information of the IoT terminal and the basic information of its corresponding user.

After the registration is completed, when it is needed to use the IoT terminal to access the IoT management platform, the user can send a login request to the IoT management platform through the IoT terminal. Generally, an IoT card built into the IoT terminal supports automatic acquisition of the address of the IoT management platform. Through the address, a login request can be sent to the IoT management platform. The connection methods between the IoT terminal and the IoT management platform include but are not limited to 4G/5G network and WIFI network. The data transmission methods between the IoT terminal and the IoT management platform include but are not limited to an MQTT protocol. The login request includes the basic information of the IoT terminal. This basic information includes but is not limited to the IoT terminal model, terminal ID, and terminal version number. In addition, in order to improve security, when the IoT terminal is connected to the IoT management platform, the login request sent and other subsequent data are all encrypted.

After receiving the login request, the IoT management platform analyzes the request to obtain the basic information of the IoT terminal, and verifies the legitimacy of the basic information. If the IoT terminal device is illegitimate or is an unknown device, the basic information of the IoT terminal is recorded for operation and maintenance personnel to handle illegitimate terminals. If the IoT terminal is a legitimate device, login success information will be returned and a connection will be established with the IoT terminal.

After establishing the connection with the IoT terminal, the IoT management platform sends a service instruction for uploading object model data to the IoT terminal. The object model data includes but are not limited to attribute information, event information and service information. The attribute information includes attribute names, identifiers, data types, value ranges, step sizes, units, read and write types and other related parameters. The event information includes event names, identifiers, data types, value ranges, step sizes, units, read and write types and other related parameters. The service information includes service types and service parameters. The service types may be data reporting, event reporting, data acquisition, parameters query, parameter configuration, etc. The service parameters can be attribute values or customized new parameters.

In S120, if the IoT terminal supports uploading its own object model data, a first object model that matches the object model data is updated according to the object model data uploaded by the IoT terminal, where the first object model is stored in the IoT management platform.

In some embodiments, such as this embodiment, step S120 may include the following steps.

In S121, whether the IoT terminal corresponding to the object model data is connected for the first time is determined.

In S122, if the IoT terminal corresponding to the object model data is connected for the first time, a first object model of the IoT terminal that matches the object model data is generated according to the object model data.

In S123, if the IoT terminal corresponding to the object model data is not connected for the first time, whether the version number of the IoT terminal is the same as the version number of the locally stored first object model is confirmed.

In S124, if the version number of the IoT terminal is different from the version number of the locally stored first object model, it proceeds to updating, according to the object model data uploaded by the IoT terminal, a first object model that matches the object model data.

In the embodiment of the present disclosure, after determining that the IoT terminal is a legitimate device, it is necessary to determine whether the IoT terminal sends a login request for the first time, that is, whether it is the first time to establish a connection. If it is not the first time for the IoT terminal to send a login request, it is indicated that the first object model of the IoT terminal is stored in the IoT management platform and it is determined whether the object model data in the first object model needs to be updated based on whether the version number of the IoT terminal matches the version number of the first object model. The object model refers to the definition of parameters, attributes, services and events of the IoT terminal, for defining which parameters, which faults, which alarm information can be reported and which services can be called on the IoT terminal. The first object model refers to the object model generated by the IoT management platform according to the object model data reported by the IoT terminal when connected to the IoT terminal for the first time. The second object model mentioned below refers to the object model generated by the big data platform according to the object model log when the IoT terminal does not support reporting object model data. When the version number of the IoT terminal corresponding to the object model data is different from the version number of the first object model, the first object model is updated according to the object model data; if the version numbers are the same, the operation is not performed.

Updating the first object model through object model data may include the following processes: the object model data uploaded by the IoT terminal is stored in the json field, ultra-long object model data may be uploaded in segments, and each piece of uploaded information includes part of the object model data. At the same time, how many segments the object model data is divided into and what segment of information the current one is will be reflected in the message. Data may be transmitted between the IoT terminal and the IoT management platform through the MQTT protocol, and certainly, the data may be transmitted through other protocols, which are not limited here. The following is explained using the MQTT protocol. When the IoT management platform receives the object model data, if the object model data is uploaded in segments, the IoT terminal will merge the received multi-segment messages. How many messages the message is divided into may be confirmed through the totalNum field in json, and which message the current message is may be confirmed through the partNum field. Generally, data are transmitted between the IoT terminal and the IoT management platform in the form of messages. When uploading the object model data, the IoT terminal will send one or more messages to the IoT management platform, and the messages contain the object model data. The IoT management platform obtains the object model data by decoding the messages. Specifically, the messages may be decoded through the binary data in the MQTT protocol to obtain a JSON message. The JSON message contains the object model attribute information and service information. The attribute information includes attribute names and data description, for example:
{“meterStatus”:{displayName:table status,data_schema:“len:2,unitName:,unit:null”}}

The service information includes field numbers, attribute names, display names, data types, and units included in the service, for example:
[{seq:1,name:meterAdd,displayName:table number,dataType:fix-string,len:14,unitName:,unit: null},
{seq:2,name:signalStrength,displayName:signal strength(CSQ),
dataType:fix-string,len:2,unitName:,unit: null},
{seq:3,name:rsrpValue,displayName: RERP,dataType:fix-string,len:4,unitName:,unit:null},
{seq:4,name:snrValue,displayName:SNR,dataType:fix-string,len:4,unitName:,unit:null}].

After decoding is completed, the decoded data in json format is formatted, and the attribute information in the above object model data is formatted into attribute Map object data. The key of the attribute Map object data is the corresponding object model attribute or parameter, where Map object is a collection of keys/values, as shown in Table (1).

TABLE 1

| Key | Value |
|---|---|
| meterStatus | displayName: table status |
| | data_schema:len:2,unitName:,unit:null |

The service information is also formatted into service Map object data. The key in the service Map object data is the service code of the corresponding object model data, as shown in Table (2).

TABLE 2

| Key | Value |
|---|---|
| 1 | name:water_consumption, |
| | displayName: water consumption, |
| | dataType:double, |
| | unit:m³, |
| | min:0, |
| | len:8, |
| | uniName:m³, |
| | max:99999999.99 |

In addition, after transcoding and formatting the object model data, the IoT management platform updates the first object model.

In S130, if the IoT terminal does not support uploading its own object model data, an object model log of the IoT terminal is acquired, and log data in the object model log is formatted to obtain target log data.

In S140, the target log data is sent to a big data platform to enable the big data platform to generate a second object model according to the target log data, and return the second object model to the IoT management platform. In some embodiments, such as this embodiment, step S140 may include the following steps: a preset object model knowledge base is acquired, and the target log data is analyzed according to the preset object model knowledge base to obtain the second object model; and the second object model is sent to the IoT management platform.

In S150, if the second object model is received, the second object model is stored.

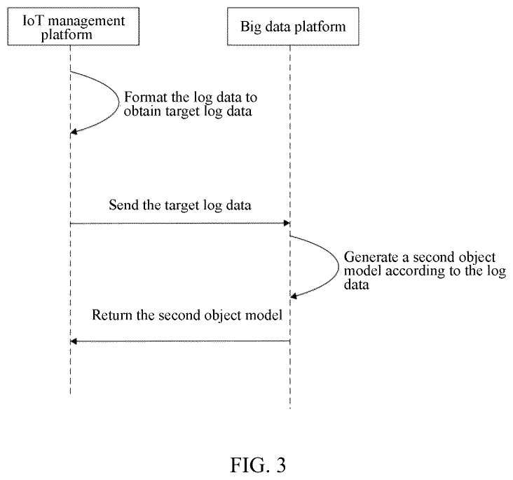

In the embodiment of the present disclosure, if supporting actively uploading object model data, the IoT terminal will actively upload the object model data after receiving a request from the IoT management platform. However, there are a large number of IoT terminals in real life that do not support actively uploading object model data. As shown in FIG. 3, for IoT terminals that do not support actively uploading object model data, the IoT management platform acquires corresponding object model logs which refer to a specific piece of data reported by the IoT terminals based on the object model. A object model log contains a plurality of pieces of data, for example, alarm data reporting. After acquiring the object model log, the IoT management platform formats the log data in the object model log to obtain target log data, and then sends the target log data to the big data platform. According to the industry of the IoT terminal corresponding to the target log data and a preset object model knowledge base, the big data platform analyzes the target log data to obtain the second object model. The IoT terminal and the IoT management platform can transmit data through the MQTT protocol or other protocols, which are not limited here.

Formatting log data includes the following processes: after receiving the log data, the IoT management platform decodes and formats the log data, and converts the data format of the log data into a data format that can be identified by the IoT management platform. The decoding and formatting methods are the same as those mentioned above, and will not be discussed here. It is worth mentioning that log data is not the same as object model data. Log data is the data content actually generated during the interaction between the IoT terminal and the IoT management platform. However, the types of information contained therein are the same. For example, both contain attribute information. In the object model log data, its attribute information is also converted into Map object data, as shown in Table (3).

TABLE 3

| Key | Value |
|---|---|
| sigStrength | 20 |
| batteryVoltage | 3.68 |
| pressure | 0000 |

The IoT management platform obtains target log attribute information after completing the decoding and formatting of the log data, and then sends the target log data to the big data platform.

In addition, the second object model generated by the big data platform according to the target log data will be marked to indicate that the second object model is generated by the big data platform. When the IoT terminal supports actively reporting object model data, both the big data platform and the IoT management platform will be updated accordingly. Based on the object model data reported by the IoT terminal, the second object model will be deleted and the first object model will be generated according to the object model data uploaded by the IoT terminal.

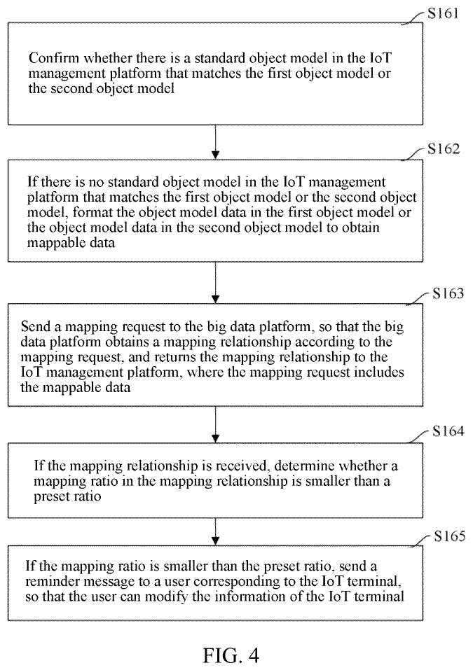

As shown in FIG. 4, in some embodiments, such as this embodiment, the method for standardizing an object model of an IoT terminal further includes the following steps.

In S161, whether there is a standard object model in the IoT management platform that matches the first object model or the second object model is confirmed. In an embodiment of the present disclosure, standard object model data refers to object model data that can be directly identified and adopted by the IoT management platform, big data platform and IoT business system. Under normal circumstances, the IoT management platform will pre-store standard object models corresponding to various IoT terminal types. A standard object model is mainly used to determine the difference between the object model of the IoT terminal and the standard object model, and to determine whether the information of the IoT terminal is compliant.

In S162, if there is no standard object model in the IoT management platform that matches the first object model or the second object model, the object model data in the first object model or the object model data in the second object model is formatted to obtain mappable data. In an embodiment of the present disclosure, if there is no standard object model that matches the first object model or the second object model in the IoT management platform, that is, there is no standard object model that matches the first object model or there is no standard object model matches the second object model, the IoT management platform formats the object model data in the first object model and the second object model. The specific process of formatting is the same as the processes of formatting object model data and formatting log data mentioned above, and will not be described here. The obtained mappable data is also Map object data, which is easy to be identified by the big data platform.

When there is a standard object model that matches the first object model or the second object model, the difference between the first object model or the second object model and the standard object model is directly confirmed to determine whether it is necessary to request the IoT terminal to supplement related Information.

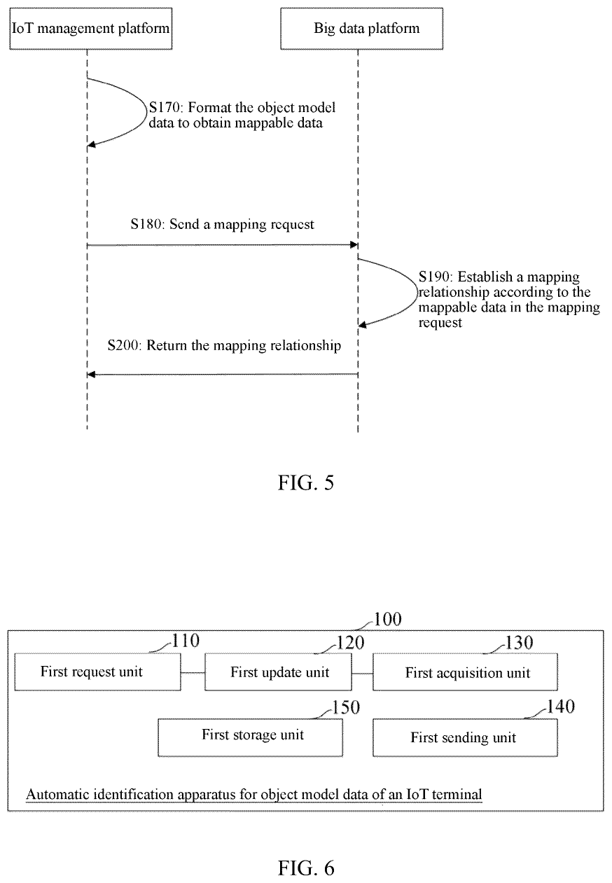

In S163, a mapping request is sent to the big data platform to enable the big data platform to obtain a mapping relationship according to the mapping request and return the mapping relationship to the IoT management platform, where the mapping request includes the mappable data. In some embodiments, such as this embodiment, step S163 may include the following steps: the mapping request is analyzed to obtain the mappable data, and word segmentation processing is performed on attribute names in the mappable data to obtain keywords; word normalization processing is performed on the keywords to obtain standard mappable data; and standard object model data in the standard object model is acquired, the mapping relationship is established according to the standard mappable data and the standard object model data, and the mapping relationship is sent to the IoT management platform. In an embodiment of the present disclosure, when there is no standard object model that matches the first object model or the second object model in the IoT management platform, as shown in FIG. 5, the IoT management platform will send a mapping request to the big data platform. The mapping request includes mappable data, and the mappable data includes but is not limited to the attribute Map object, service Map object and version number of the first object model or the second object model, and industry data of the IoT terminal. After receiving the mappable data, the big data platform preprocesses the mappable data so that the format of the mappable data is the same as the format of the standard object model data, which facilitates the analysis of the mapping relationship and mapping ratio between the two, and finally the results are fed back to the IoT management platform.

If the big data platform receives mappable data for the first time, there will generally be no matching mapping relationship. The mapping relationship refers to the mapping relationship between the object model and the standard object model, and in actual use, is gradually established after the object model of the IoT terminal is analyzed. The big data platform will pre-store standard object models of various industries or types of IoT terminals, and after receiving the mappable data, identify the type of the IoT terminal through the mappable data and confirm standard object model data that matches the type of the IoT terminal.

Generally, mappable data cannot directly establish a mapping relationship with standard object model data due to differences in data formats between mappable data and standard object model data. Therefore, the mappable data needs to be preprocessed. Specifically, data in the mappable data can be segmented and normalized successively. In addition, based on the actual situation, data in the mappable data can be processed by inflectional morphology, lemmatization (for example, Speaking is reduced to Speak), derived morphological processing (for example, final is converted to finalise), and other data analysis and processing operations.

When performing word segmentation processing, since an attribute name is not a complete sentence and is usually composed of 1-3 English keywords. Common word segmentation methods are accomplished based on “_” segmentation, capital initial letter segmentation, naive segmentation or Subword segmentation. Subword segmentation requires the big data platform to pre-establish a large corpus, followed by training on the corpus. For example, the attribute DEVICE_IP_ADDR will be divided into words DEVICE, IP and ADDR. After the word segmentation processing is completed, the keywords need to be normalized, which mainly includes spelling correction of the keywords, removing the morphological information of the English words and expanding the abbreviations. For example, ADDR needs to be restored to Address.

After word segmentation and word normalization are completed, the preprocessing of the mappable data is completed. The standard object model data of the pre-stored standard object model may be acquired, and then the mapping relationship between the mappable data and the standard object model data may be established. When establishing the object model mapping relationship, there will be information that is in the mappable data but not in the standard object model data. Such information may be identified as personalized information. For information that can be matched, the mapping relationship is directly established. Then, the mapping ratio is confirmed based on the proportion of information that can establish the mapping relationship to all information, and the object model mapping relationship and mapping ratio are returned to the IoT management platform.

In some embodiments, such as this embodiment, establishing the mapping relationship based on the standard mappable data and the standard object model data may include the following steps: whether there is data information that matches the standard object model data in the standard mappable data is determined; if there is data information that matches the standard object model data in the standard mappable data, a data mapping relationship between the matching data information is established; if there is no data information that matches the standard object model data in the standard mappable data, the data information is identified as personalized information; and the data mapping relationship and the personalized information are used as the mapping relationship.

In an embodiment of the present disclosure, the purpose of establishing a mapping relationship is to match the data information in the mappable data with the data information in the standard object model data. For example, for an attribute information Device IP Addr in the mappable data, the corresponding attribute information in the standard object model data is WATERAFFAIR: IPADDRESS, both describing the same information and thus being able to establish a mapping relationship. When the data information in the mappable data cannot match the data information in the standard object model data, it is indicated that the information is the personalized information unique to the IoT terminal. Generally, an IoT terminal does not have too much personalized information. The mapping relationship includes the established data mapping relationship and personalized information. Meanwhile, operators can regularly update the standard object model data through the big data platform, and supplement some personalized information to the standard object model data.

The object model mapping relationship obtained through the above steps includes mapping relationship information and personalized information. The mapping ratio is confirmed by calculating the proportion of mapping relationship information to all information. Table (4) shows the object model mapping relationship table.

TABLE 4

| Object model | | | |
|---|---|---|---|
| attribute of | Standard object | | Personalized object |
| IoT terminal | model attribute | Mappable | model parameter |
| ecl | WATER AFFAIR: | Yes | |
| | ECL | | |
| Device IP Addr | WATER AFFAIR: | Yes | |
| | IP ADDRESS | | |
| Reverse Pressure | | No | WATER AFFAIR: |
| | | | tenant identifier: |
| | | | REVERSE |
| | | | PRESSURE |

As shown in Table (4), the mapping relationship table includes three pieces of information, two of which establish a data mapping relationship, and the other one is personalized information, so that the mapping ratio is two-thirds. After obtaining the mapping relationship, the big data platform stores the mapping relationship and the object model version number in a relational database, and stores the personalized information in the personalized information database.

In S164, if the mapping relationship is received, whether the mapping ratio is less than a preset ratio is determined according to a mapping ratio in the mapping relationship; S165, if the mapping ratio is less than the preset ratio, a reminder message is sent to a user corresponding to the IoT terminal, so that the user can modify the information of the IoT terminal. In an embodiment of the present disclosure, after receiving the mapping relationship fed back by the big data platform, the IoT management platform will determine, according to the mapping ratio in the mapping relationship, whether it is necessary to remind the user corresponding to the IoT terminal to supplement relevant information. For example, if the mapping ratio is lower than 30%, it is indicated that there is a big difference between the first object model or the second object model and the standard object model, indicating that the object model data uploaded by the IoT terminal is abnormal and is greatly different from the actual situation, and the user needs to supplement relevant information. When the mapping ratio is normal, it is indicated that the difference between the object model data uploaded by the user terminal and the actual situation is small, and there is no need to supplement relevant information.

FIG. 6 is a schematic block diagram of a standardizing apparatus 100 for an object model of an IoT terminal provided by an embodiment of the present disclosure. As shown in FIG. 6, corresponding to the above method for standardizing an object model of an IoT terminal, the present disclosure further provides a standardizing apparatus 100 for an object model of an IoT terminal. The standardizing apparatus 100 for an object model of an IoT terminal includes units for executing the above method for standardizing an object model of an IoT terminal. Specifically, referring to FIG. 6, the standardizing apparatus 100 for an object model of an IoT terminal includes a first request unit 110, a first update unit 120, a first acquisition unit 130, a first sending unit 140, and a first storage unit 150. The first request unit 110 is configured to request an IoT terminal connected to an IoT management platform to upload respective object model data. The first update unit 120 is configured to, if the IoT terminal supports uploading its own object model data, update, according to the object model data uploaded by the IoT terminal, a first object model that matches the object model data, where the first object model is stored in the IoT management platform. The first acquisition unit 130 is configured to, if the IoT terminal does not support uploading its own object model data, acquire an object model log of the IoT terminal, and format log data in the object model log to obtain target log data. The first sending unit 140 is configured to send the target log data to a big data platform, so that the big data platform generates a second object model according to the target log data, and returns the second object model to the IoT management platform. The first storage unit 150 is configured to, if the second object model is received, store the second object model.

In some embodiments, such as this embodiment, the first update unit 120 includes a first determination unit, a first generation unit, a first confirmation unit, and a first return unit. The first determination unit is configured to determine whether the IoT terminal corresponding to the object model data is connected for the first time. The first generation unit is configured to, if the IoT terminal corresponding to the object model data is connected for the first time, generate, according to the object model data, a first object model of the IoT terminal that matches the object model data. The first confirmation unit is configured to, if the IoT terminal corresponding to the object model data is not connected for the first time, confirm whether the version number of the IoT terminal is the same as the version number of the locally stored first object model. The first return unit is configured to, if the version number of the IoT terminal is different from the version number of the locally stored first object model, update, according to the object model data uploaded by the IoT terminal, a first object model that matches the object model data.

In some embodiments, such as this embodiment, the first sending unit 140 includes a second acquisition unit and a second sending unit. The second acquisition unit is configured to acquire a preset object model knowledge base, and analyze the target log data according to the preset object model knowledge base to obtain the second object model. The second sending unit is configured to send the second object model to the IoT management platform.

In some embodiments, such as this embodiment, the standardizing apparatus 100 for an object model of an IoT terminal further includes a second determination unit, a second return unit, and a first processing unit. The second determination unit is configured to, if a login request sent by the IoT terminal is received, analyze the login request to obtain basic information of the IoT terminal, and verify the basic information to determine whether the IoT terminal is a legitimate device. The second return unit is configured to, if the IoT terminal is a legitimate device, return login success information to the IoT terminal and establish a connection with the IoT terminal. The first processing unit is configured to, if the IoT terminal is an illegitimate device, reject the login request of the IoT terminal.

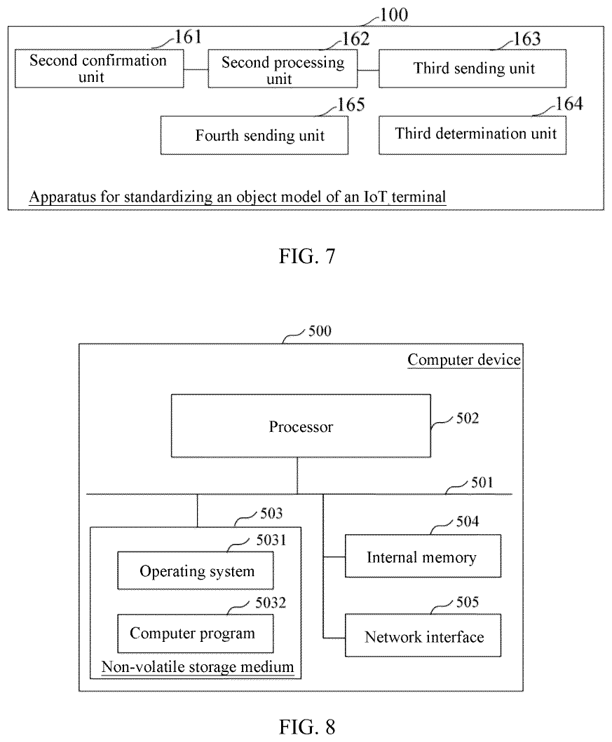

In some embodiments, such as this embodiment, as shown in FIG. 7, the standardizing apparatus 100 for an object model of an IoT terminal further includes a second confirmation unit 161, a second processing unit 162, a third sending unit 163, a third determination unit 164, and a fourth sending unit 165. The second confirmation unit 161 is configured to confirm whether there is a standard object model in the IoT management platform that matches the first object model or the second object model. The second processing unit 162 is configured to, if there is no standard object model in the IoT management platform that matches the first object model or the second object model, format the object model data in the first object model or the object model data in the second object model to obtain mappable data. The third sending unit 163 is configured to send a mapping request to the big data platform, so that the big data platform obtains a mapping relationship according to the mapping request, and returns the mapping relationship to the IoT management platform, where the mapping request includes the mappable data. The third determination unit 164 is configured to, if the mapping relationship is received, determine whether a mapping ratio in the mapping relationship is smaller than a preset ratio. The fourth sending unit 165 is configured to, if the mapping ratio is smaller than the preset ratio, send a reminder message to a user corresponding to the IoT terminal, so that the user can modify the information of the IoT terminal.

In some embodiments, such as this embodiment, the third sending unit 163 includes a first analyzing unit, a third processing unit, and a fourth processing unit. The first analyzing unit is configured to analyze the mapping request to obtain the mappable data, and perform word segmentation processing on attribute names in the mappable data to obtain keywords. The third processing unit is configured to perform word normalization processing on the keywords to obtain standard mappable data. The fourth processing unit is configured to acquire standard object model data in the standard object model, establish the mapping relationship according to the standard mappable data and the standard object model data, and send the mapping relationship to the IoT management platform.

In some embodiments, such as this embodiment, the fourth processing unit includes a fourth determination unit, a fifth processing unit, a first marking unit, and a sixth processing unit. The fourth determination unit is configured to determine whether there is data information that matches the standard object model data in the standard mappable data. The fifth processing unit is configured to, if there is data information that matches the standard object model data in the standard mappable data, establish a data mapping relationship between the matching data information. The first marking unit is configured to, if there is no data information that matches the standard object model data in the standard mappable data, identify the data information as personalized information. The sixth processing unit is configured to use the data mapping relationship and the personalized information as the mapping relationship.

It is to be noted that those of ordinary skills in the art can clearly understand that for the above apparatus for standardizing an object model of an IoT terminal and the specific implementation process of each unit, reference may be made to the corresponding descriptions in the foregoing method embodiments, which, for convenience and simplicity of description, will not be described in detail here.

The above apparatus for standardizing an object model of an IoT terminal may be implemented in the form of a computer program which may be run on the computer device as shown in FIG. 8.

FIG. 8 shows a schematic block diagram of a computer device provided by an embodiment of the present disclosure. Referring to FIG. 8, the computer device 500 includes a processor 502, a memory, and an interface 505 which are connected through a system bus 501, where the memory may include a non-volatile storage medium 503 and an internal memory 504.

The non-volatile storage medium 503 may store an operating system 5031 and a computer program 5032. The computer program 5032, when executed by the processor 502, may cause the processor 502 to execute the method for standardizing an object model of an IoT terminal according to any one of the above embodiments.

The processor 502 is configured to provide computing and control capabilities, so as to support the operation of the entire computer device 500.

The internal memory 504 provides an environment for the running of the computer program 5032 in the non-volatile storage medium 503. The computer program 5032, when executed by the processor 502, may cause the processor 502 to execute the method for standardizing an object model of an IoT terminal according to any one of the above embodiments.

The interface 505 is configured to communicate with other devices. Those of ordinary skills in the art can understand that the structure shown in FIG. 8 is merely a block diagram of a partial structure related to the solution of the present disclosure, and does not constitute a limitation on the computer device 500 to which the solution of the present disclosure is applied. The specific computer device 500 may include more or fewer components than shown, or combine some components, or have a different component arrangement.

It should be understood that in the embodiments of the present disclosure, the processor 502 may be a Central Processing Unit (CPU). The processor 502 may also be other general-purpose processors, Digital Signal Processors (FSPs), Application Specific Integrated Circuits (ASICs), Field-Programmable Gate Arrays (FPGAs) or other programmable logic devices, discrete gates or transistor logic devices, discrete hardware components, etc. The general processors may be microprocessors or the processors may be any conventional processors.

Those of ordinary skill in the art can understand that all or part of the processes in the method of implementing the above embodiments may be completed by instructing relevant hardware through a computer program. The computer program may be stored in a storage medium, which is a computer-readable storage medium. The computer program is executed by at least one processor in the computer system to implement the steps of the method in the above embodiments.

Therefore, the present disclosure further provides a storage medium, which may be a computer-readable storage medium. The storage medium has a computer program stored therein which, when executed by a processor, causes the processor to implement the method for standardizing an object model of an IoT terminal according to any one of the above embodiments.

The storage medium may be a USB flash drive, a mobile hard disk, a Read-Only Memory (ROM), a magnetic disk or an optical disk, and other computer-readable storage media that can store program code.

Those of ordinary skills in the art can appreciate that the units and algorithm steps of each example described in conjunction with the embodiments disclosed herein can be implemented with electronic hardware, computer software, or a combination of both. In order to clearly illustrate the interchangeability between hardware and software, in the above description, the composition and steps of each example have been generally described according to functions. Whether these functions are performed in hardware or software depends on the specific application and design constraints of the technical solution. Those of ordinary skills in the art may implement the described functionality using different methods for each specific application, but such implementations should not be considered to be beyond the scope of the present disclosure.

In the several embodiments provided by the present disclosure, it is to be understood that the disclosed apparatus and method may be implemented in other ways. For example, the apparatus embodiments described above are merely illustrative. For example, the division of each unit is merely a logical function division, and there may be other division methods during actual implementation. For example, a plurality of units or components may be combined or integrated into another system, or some features may be omitted, or not implemented. The steps in the methods of the embodiments of the present disclosure may be adjusted in order, combined, or deleted according to actual needs. The units in the apparatus of the embodiments of the present disclosure may be merged, divided or deleted according to actual needs. In addition, various functional units in various embodiments of the present disclosure may be integrated into one processing unit, or each unit may exist physically alone, or two or more units may be integrated into one unit. If implemented in the form of a software functional unit and sold or used as an independent product, the integrated unit may be stored in a storage medium. Based on this understanding, the essential part or the part contributing to the existing technology in the technical solution of the present disclosure, or all or part of the technical solution may be embodied in the form of a software product, and the computer software product is stored in a storage medium, including several instructions for causing a computer device to execute all or part of the steps of the method described in various embodiments of the present disclosure. In the above embodiments, each embodiment is described with its own emphasis. For parts that are not described in detail in a certain embodiment, reference may be made to the relevant descriptions of other embodiments. Obviously, those of ordinary skills in the art can make various changes and modifications to the present disclosure without departing from the gist and scope of the present disclosure. In this way, as long as these changes and modifications to the present disclosure fall within the scope of the claims of the present disclosure and equivalent technologies, the present disclosure is also intended to include these changes and modifications. The above are merely specific embodiments of the present disclosure, but the protection scope of the present disclosure is not limited thereto. Those of ordinary skills in the art can readily contemplate various equivalent modifications or substitutions within the technical scope in the present disclosure, and these modifications or substitutions shall all fall within the scope of protection of the present disclosure. Therefore, the scope of protection of the present disclosure should be subject to the scope of protection of the claims.

1. A method for standardizing an object model of an Internet of Things (IoT) terminal, applied to an IoT management platform, the method comprising:
requesting an IoT terminal connected to the IoT management platform to upload respective object model data;
in response to the IoT terminal supporting uploading its own object model data, updating, according to the object model data uploaded by the IoT terminal, a first object model that matches the object model data, wherein the first object model is stored in the IoT management platform;
in response to the IoT terminal not supporting uploading its own object model data, acquiring an object model log of the IoT terminal, and formatting log data in the object model log to obtain target log data;
sending the target log data to a big data platform to enable the big data platform to generate a second object model according to the target log data and return the second object model to the IoT management platform; and
in response to receiving the second object model, storing the second object model.

2. The method for standardizing an object model of an IoT terminal according to claim 1, further comprising:
confirming whether there is a standard object model in the IoT management platform that matches the first object model or the second object model;
in response to there being no standard object model in the IoT management platform that matches the first object model or the second object model, formatting the object model data in the first object model or the object model data in the second object model to obtain mappable data;
sending a mapping request to the big data platform to enable the big data platform to obtain a mapping relationship according to the mapping request and return the mapping relationship to the IoT management platform, wherein the mapping request comprises the mappable data;
in response to receiving the mapping relationship, determining whether a mapping ratio in the mapping relationship is less than a preset ratio; and
in response to the mapping ratio being less than the preset ratio, sending a reminder message to a user corresponding to the IoT terminal to enable the user to modify information of the IoT terminal.

3. The method for standardizing an object model of an IoT terminal according to claim 2, wherein obtaining the mapping relationship according to the mapping request and returning the mapping relationship to the IoT management platform by the big data platform comprises:
analyzing the mapping request to obtain the mappable data, and performing word segmentation processing on attribute names in the mappable data to obtain keywords;
performing word normalization processing on the keywords to obtain standard mappable data; and
acquiring standard object model data in the standard object model, establishing the mapping relationship according to the standard mappable data and the standard object model data, and sending the mapping relationship to the IoT management platform.

4. The method for standardizing an object model of an IoT terminal according to claim 3, wherein establishing the mapping relationship according to the standard mappable data and the standard object model data comprises:
determining whether there is data information that matches the standard object model data in the standard mappable data;
in response to there being data information that matches the standard object model data in the standard mappable data, establishing a data mapping relationship between the matching data information;
in response to there being no data information that matches the standard object model data in the standard mappable data, identifying the data information as personalized information; and
using the data mapping relationship and the personalized information as the mapping relationship.

5. The method for standardizing an object model of an IoT terminal according to claim 1, wherein generating the second object model according to the target log data and returning the second object model to the IoT management platform by the big data platform comprises:
acquiring a preset object model knowledge base, and analyzing the target log data according to the preset object model knowledge base to obtain the second object model; and
sending the second object model to the IoT management platform.

6. The method for standardizing an object model of an IoT terminal according to claim 1, wherein before requesting an IoT terminal connected to the IoT management platform to upload respective object model data, the method further comprises:
in response to receiving a login request sent by the IoT terminal, analyzing the login request to obtain basic information of the IoT terminal, and verifying the basic information to determine whether the IoT terminal is a legitimate device;
in response to the IoT terminal being a legitimate device, returning login success information to the IoT terminal and establishing a connection with the IoT terminal; and
in response to the IoT terminal being an illegitimate device, rejecting the login request of the IoT terminal.

7. The method for standardizing an object model of an IoT terminal according to claim 1, wherein updating, according to the object model data uploaded by the IoT terminal, a first object model that matches the object model data comprises:
determining whether the IoT terminal corresponding to the object model data is connected for the first time;
in response to the IoT terminal corresponding to the object model data being connected for the first time, generating, according to the object model data, a first object model of the IoT terminal that matches the object model data;
in response to the IoT terminal corresponding to the object model data being not connected for the first time, confirming whether a version number of the IoT terminal is identical to a version number of a locally stored first object model; and
in response to the version number of the IoT terminal being different from the version number of the locally stored first object model, updating, according to the object model data uploaded by the IoT terminal, the first object model that matches the object model data.

8. An apparatus for standardizing an object model of an Internet of Things (IoT) terminal, comprising:
a first request unit, configured to request an IoT terminal connected to an IoT management platform to upload respective object model data;
a first update unit, configured to, in response to the IoT terminal supporting uploading its own object model data, update, according to the object model data uploaded by the IoT terminal, a first object model that matches the object model data, wherein the first object model is stored in the IoT management platform;
a first acquisition unit, configured to, in response to the IoT terminal not supporting uploading its own object model data, acquire an object model log of the IoT terminal, and format log data in the object model log to obtain target log data;
a first sending unit, configured to send the target log data to a big data platform to enable the big data platform to generate a second object model according to the target log data and return the second object model to the IoT management platform; and
a first storage unit, configured to, in response to receiving the second object model, store the second object model.

9. A computer device, comprising a memory and a processor connected to the memory, wherein the memory is configured to store computer programs which, when executed by the processor, causes the processor to perform the method according to claim 1.

10. A non-transitory computer-readable storage medium, having computer programs stored therein which, when executed by a processor of a computer device, cause the computer device to implement the method according to claim 1.
